(19) United States
(12) Patent Application Publication
(10) Pub. No.: US 2011/0245957 A1
(43) Pub. Date: Oct. 6, 2011

(54) ADVANCED PLATFORM FOR PROCESSING CRYSTALLINE SILICON SOLAR CELLS

(75) Inventors: KEITH B. PORTHOUSE, Sunnyvale, CA (US); Tristan R. Holtam, Saratoga, CA (US); Lisong Zhou, Sunnyvale, CA (US); Vinay K. Shah, San Francisco, CA (US); Damon K. Cox, Round Rock, TX (US)

(73) Assignee: APPLIED MATERIALS, INC., Santa Clara, CA (US)

(21) Appl. No.: 12/755,255

(22) Filed: Apr. 6, 2010

(51) Int. Cl. G06F 19/00; B08B 1/02

(52) U.S. Cl. 700/114; 134/32; 901/2

(57) ABSTRACT

The present invention generally provides a batch substrate processing system for in-situ processing of a film stack used to form regions of a solar cell device. The batch processing system is configured to process an array of substrates positioned on a substrate carrier. The batch processing system includes a substrate transport interface that provides loading an unloading of the array of substrates in a production line environment. The substrate transport interface may include one or more of a substrate carrier cleaning module, a substrate carrier cooling module, and a substrate carrier buffer module.

### CROSS-REFERENCE TO RELATED APPLICATIONS

This application is related to U.S. patent application Ser. No. 12/575,088 [Attny. Docket No. APPM/13855] filed on Oct. 7, 2009, which is herein incorporated by reference in its entirety.

### BACKGROUND OF THE INVENTION

1. Field of the Invention

Embodiments of the invention generally relate to an apparatus and method for forming a solar cell device. The invention is particularly useful for fabrication of crystalline silicon solar cells processed in batches arranged in planar arrays.

2. Description of the Related Art

Photovoltaic (PV) or solar cells are devices which convert sunlight into direct current (DC) electrical power. A typical PV cell includes a p-type silicon wafer, or substrate, typically less than about 0.3 mm thick, with a thin layer of an n-type silicon material disposed on top of the p-type substrate. The generated voltage, or photo-voltage, and generated current by the PV cell are dependent on the material properties of the p-n junction, the interfacial properties between deposited layers, and the surface area of the device. When exposed to sunlight (consisting of energy from photons), the p-n junction of the PV cell generates pairs of free electrons and holes. An electric field formed across a depletion region of the p-n junction separates the free electrons and holes, creating a voltage. A circuit from n-side to p-side allows the flow of electrons when the PV cell is connected to an electrical load. Electrical power is the product of the voltage times the current generated as the electrons and holes move through the external electrical load and eventually recombine. Each solar cell generates a specific amount of electrical power. A plurality of solar cells is tiled into modules sized to deliver the desired amount of system power.

The PV market has experienced growth with annual growth rates exceeding above30% for the last ten years. Some articles have suggested that solar cell power production world wide may exceed 10 GWp in the near future. It has been estimated that more than 90% of all photovoltaic modules are silicon wafer based. The high market growth rate in combination with the need to substantially reduce solar electricity costs has resulted in a number of serious challenges for silicon wafer production development for photovoltaics.

In order to meet these challenges, the following solar cell processing requirements generally need to be met: 1) the cost of ownership (CoO) for substrate fabrication equipment needs to be improved (e.g., high system throughput, high machine up-time, inexpensive machines, inexpensive consumable costs), 2) the area processed per process cycle needs to be increased (e.g., reduce processing per Wp) and 3) the quality of the formed layers and film stack formation processes needs to be well controlled and be sufficient to produce highly efficient solar cells. Therefore, there is a need to cost effectively form and manufacture silicon sheets for solar cell applications.

Further, as the demand for solar cell devices continues to grow, there is a trend to reduce cost by increasing the substrate throughput and improving the quality of the deposition processes performed on the substrate. However, the cost associated with producing and supporting all of the processing components in a solar cell production line continues to escalate dramatically. To reduce this cost while also reducing surface contamination, it is desirable to design a novel solar cell processing system configuration and processing sequence to eliminate and/or combine processing steps and to accommodate sequential processing steps in the processing system that has a high throughput, improved device yield, and a compact footprint.

### SUMMARY OF THE INVENTION

In one embodiment of the present invention, a processing system comprises one or more process chambers each having a substrate supporting surface configured to receive and process an array of substrates positioned on a substrate carrier, a load lock chamber coupled to the one or more process chambers and having one or more regions with a substrate supporting surface configured to receive and support the array of substrates positioned on the substrate carrier, and a substrate carrier interface module positioned adjacent the load lock chamber. In one embodiment, the substrate carrier interface module comprises one or more substrate transfer modules configured to load substrates onto the substrate carrier and unload substrates off of the substrate carrier and a substrate interface module having a transfer robot configured to transfer the array of substrates on the substrate carrier from the one or more substrate transfer modules to the one or more regions of the load lock chamber and from the one or more regions of the load lock chamber to the one or more substrate transfer modules. In one embodiment, the one or more substrate transfer modules include at least one of a substrate carrier cooling module, a substrate carrier cleaning module, and a substrate carrier buffer module.

In another embodiment of the present invention, a substrate carrier loading and unloading system comprises a first substrate transfer module configured to load an array of substrates onto a substrate carrier, a second substrate transfer module configured to unload the array of substrates from the substrate carrier, and a substrate interface module having a substrate carrier transfer robot configured to transfer the array of substrates on the substrate carrier from the first substrate transfer module into a processing system and out of the processing system to the second substrate transfer module. In one embodiment, the substrate carrier transfer robot is further configured to transfer the substrate carrier from the second substrate transfer module to the first substrate transfer module. In one embodiment, the first substrate transfer module comprises a substrate carrier cleaning module, a first substrate carrier lift module, a substrate carrier loading conveyor, and one or more first substrate transfer robots. In one embodiment, the second substrate transfer module comprises a substrate carrier cooling module, a second substrate carrier lift module, a substrate carrier unloading conveyor, and one or more second substrate transfer robots.

In yet another embodiment of the present invention, a method of forming a solar cell device comprises cleaning a substrate carrier in a carrier cleaning module, transferring the substrate carrier from the carrier cleaning module to a substrate loading position in a first substrate transfer module, positioning an array of substrates on the substrate carrier in the first substrate transfer module, transferring the substrate carrier from the first substrate transfer module to a load lock chamber using a substrate carrier transfer robot, transferring the substrate carrier from the load lock chamber to one or more process chambers and processing the array of substrates on the substrate carrier, transferring the substrate carrier from the one or more process chambers to the load lock chamber, transferring the substrate carrier from the load lock chamber to a carrier cooling module using the substrate carrier transfer robot and cooling the substrate carrier in the carrier cooling module, transferring the substrate carrier from the carrier cooling module to a substrate unloading position in a second substrate transfer module, and removing the array of substrates from the substrate carrier in the second substrate transfer module.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is schematic plan view of one embodiment of a substrate processing system according to one embodiment described herein.

FIG. 2 is a schematic plan view of a substrate carrier according to one embodiment described herein.

FIG. 3 is a schematic plan view of a substrate processing system according to one embodiment described herein.

FIG. 4A is a schematic front view of a substrate transport interface according to one embodiment of the present invention.

FIG. 4B is a schematic front view of a substrate transport interface according to another embodiment of the present invention.

FIG. 4C is a schematic front view of a substrate transport interface according to yet another embodiment of the present invention.

FIG. 5 is a schematic, cross-sectional view of a cleaning module according to one embodiment of the present invention.

FIG. 6 is a schematic, cross-sectional view of a cooling module according to one embodiment of the present invention.

FIG. 7 is a schematic, cross-sectional view of the buffer module according to one embodiment of the present invention.

FIG. 8 is a schematic cross-sectional view of a load lock chamber according to one embodiment described herein.

FIG. 9 is a schematic cross-section view of a processing chamber according to one embodiment described herein.

For clarity, identical reference numerals have been used, where applicable, to designate identical elements that are common between figures. It is contemplated that features of one embodiment may be incorporated in other embodiments without further recitation.

### DETAILED DESCRIPTION

The present invention generally provides a batch substrate processing system, or cluster tool, for in-situ processing of a film stack used to form regions of a solar cell device. In one configuration, a film stack formed on each of the substrates in the batch contains one or more passivating or dielectric layers and one or more metal layers that are deposited and further processed within various processing chambers contained in the processing system. The processing chambers may be, for example, physical vapor deposition (PVD) or sputtering chambers, plasma enhanced chemical vapor deposition (PECVD) chambers, low pressure chemical vapor deposition (LPCVD) chambers, hot wire chemical vapor deposition (HWCVD) chambers, ion implant/doping chambers, plasma nitridation chambers, atomic layer deposition (ALD) chambers, plasma or vapor chemical etching chambers, laser anneal chambers, rapid thermal oxidation (RTO) chambers, rapid thermal nitridation (RTN) chambers, rapid thermal annealing (RTA) chambers, substrate reorientation chambers (e.g., flipping chambers), vapor etching chambers, forming gas or hydrogen annealers, plasma cleaning chambers, and/or other similar processing chambers.

The substrate processing system may include one or more deposition chambers in which a batch of substrates is exposed to one or more gas-phase materials or RF plasma. In one embodiment, the processing system includes at least one plasma enhanced chemical vapor deposition (PECVD) process chamber that has been adapted to simultaneously process a plurality of substrates. In one embodiment, a batch of solar cell substrates is simultaneously transferred in a vacuum or inert environment to prevent substrate contamination and improve substrate throughput. In the various embodiments of the present invention, each batch of substrates is arranged in a planar array for processing as opposed to processing vertical stacks of substrates (e.g., batches of substrates stacked in cassettes). Such processing of batches of substrates arranged in planar arrays allows each of the substrates in the batch to be directly and uniformly exposed to the generated plasma, radiant heat, and/or processing gases so that each substrate in the planar array is similarly processed in the processing region of a processing chamber. Thus, processing batches of substrates in planar arrays does not rely on diffusion type processes or the serial transfer of energy to all substrates, such as in conventionally configured vertical stack or back-to-back batch processing.

In one embodiment, the present invention provides for processing a planar array of substrates on a substrate carrier. The substrate carrier may be loaded and unloaded in an automated manner in a production line environment. In one embodiment, the invention provides a cleaning module for cleaning the substrate carrier prior to loading the array of substrates onto the substrate carrier in order to ensure that any debris present on the substrate carrier from previous processing does not inhibit precise and accurate positioning of the array of substrates or introduce contaminants in subsequent processing of the array of substrates. In one embodiment, the invention provides for cooling the substrate carrier having an array of processed substrates disposed thereon in order to inhibit excessive native oxide formation on substrates subsequently loaded onto the substrate carrier. In one embodiment, the present invention provides a buffer module for receiving and storing empty substrate carriers in order to optimize process system utilization during line stoppages.

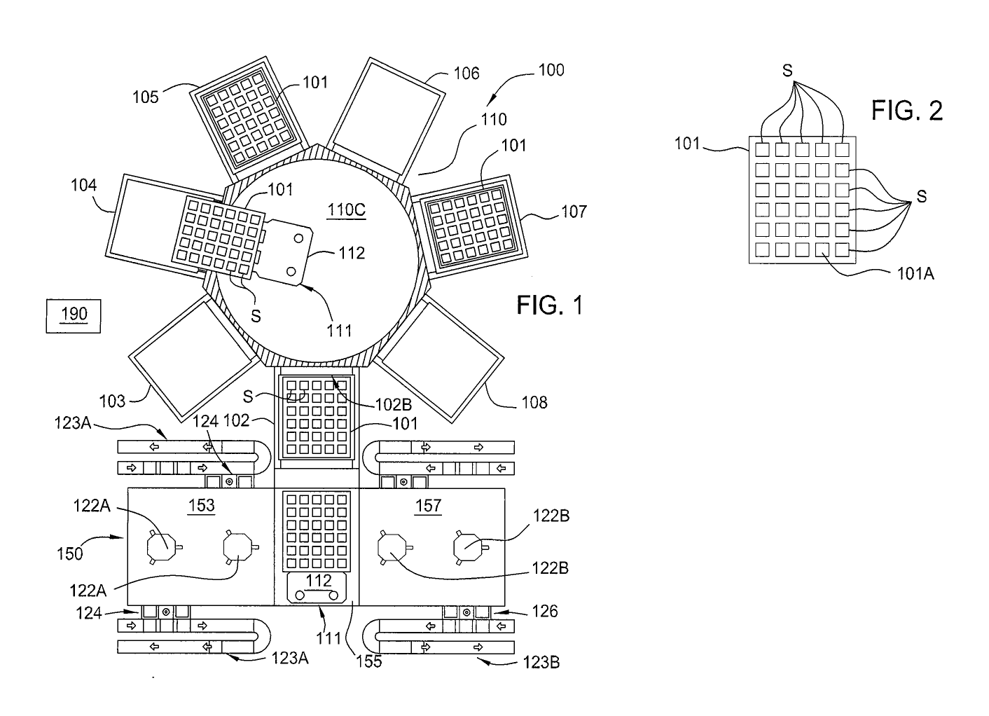

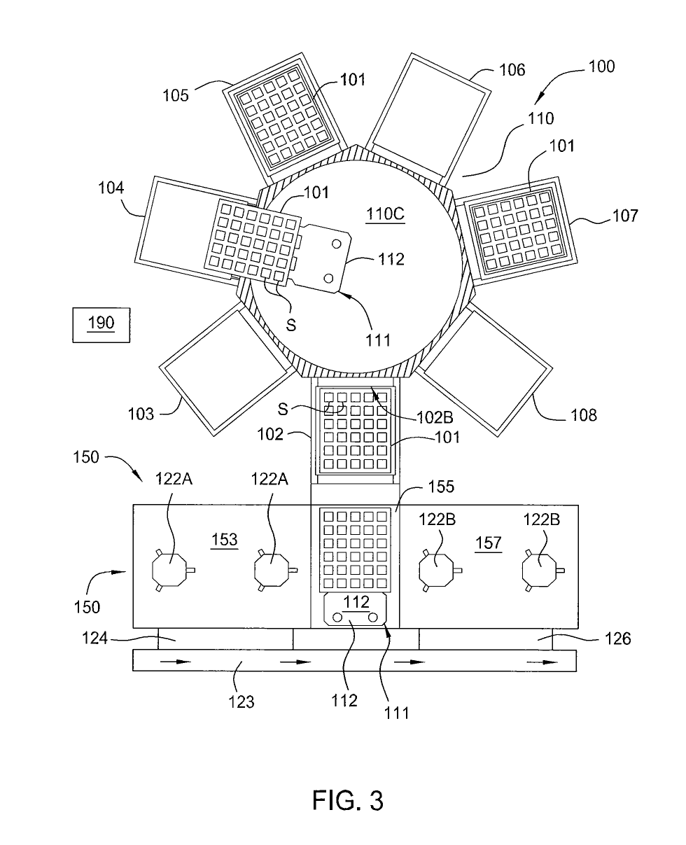

FIGS. 1 and 3 illustrate various embodiments of the substrate processing system 100 for performing one or more solar cell fabrication processes on a planar array, or batch, of substrates according to the present invention. One suitable processing system that may be adapted to perform one or more of the processes discussed herein may include a processing platform, such as a Gen. 5, Gen. 6, or Gen. 8 processing platform, available from Applied Materials, Inc., located in Santa Clara, Calif.

In one embodiment, the substrate processing system 100 typically includes a transfer chamber 110 that is coupled to a substrate transport interface 150 via a load lock chamber 102. In certain embodiments, the substrate processing system 100 has a single transfer chamber 110 connected to multiple processing chambers and one or more substrate transport interfaces. In other embodiments, the substrate processing system 100 has a multiple transfer chamber configuration to connect multiple processing chambers and substrate transport interfaces. Each transfer chamber 110 generally contains a substrate carrier transfer robot 111 that is adapted to transfer substrates among a plurality of processing chambers (e.g., reference numerals 103-108) and load lock chambers (e.g., reference numerals 102). Examples of robots that may be adapted for use in the processing system 100 are disclosed in commonly owned U.S. application Ser. No. 12/247,135 filed on Oct. 7, 2008 by Kurita et al. and U.S. Pat. No. 6,847,730 issued on Jan. 25, 2005 to Beer et al., both of which are incorporated by reference in their entireties herein to the extent not inconsistent with the present disclosure.

In one embodiment, the processing chambers 103-108 are selectively sealably coupled to a transferring region 110C of the transfer chamber 110 by use of slit valves (not shown). Each slit valve is configured to selectively isolate the processing region in one of the processing chambers 103-108 from the transferring region 110C and is disposed adjacent to the interface between the processing chambers 103-108 and the transfer chamber 110. In one embodiment, the transfer chamber 110 is maintained at a vacuum condition to eliminate or minimize pressure differences between the transfer chamber 110 and the individual processing chambers 103-108, which are typically used to process the substrates under a vacuum condition. In an alternate embodiment, the transfer chamber 110 and the individual processing chambers 103-108 are used to process the substrates in a clean and inert atmospheric pressure environment.

It should be noted that the number and orientation of processing chambers (e.g., reference numerals 103-108) shown in the attached figures is not intended to limit the scope of the invention, since these configurational details can be adjusted without deviating from the basic scope of the invention described herein. For instance, FIGS. 1 and 3 show a seven chamber configuration. Other embodiments of the invention may include a configuration with fewer or more chambers depending on the specific processing to be performed on a specific batch size of substrates without deviating from the scope of the present invention.

Generally, the substrate processing system 100 includes a system controller 190 configured to control the automated aspects of the system. The system controller 190 facilitates the control and automation of the overall substrate processing system 100 and may include a central processing unit (CPU) (not shown), memory (not shown), and support circuits (or I/O) (not shown). The CPU may be one of any form of computer processors that are used in industrial settings for controlling various chamber processes and hardware (e.g., conveyors, motors, fluid delivery hardware, etc.) and monitor the system and chamber processes (e.g., substrate position, process time, detector signal, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the system controller 190 determines which tasks are performable on a substrate. Preferably, the program is software readable by the system controller 190, which includes code to generate and store at least substrate positional information, the sequence of movement of the various controlled components, and any combination thereof.

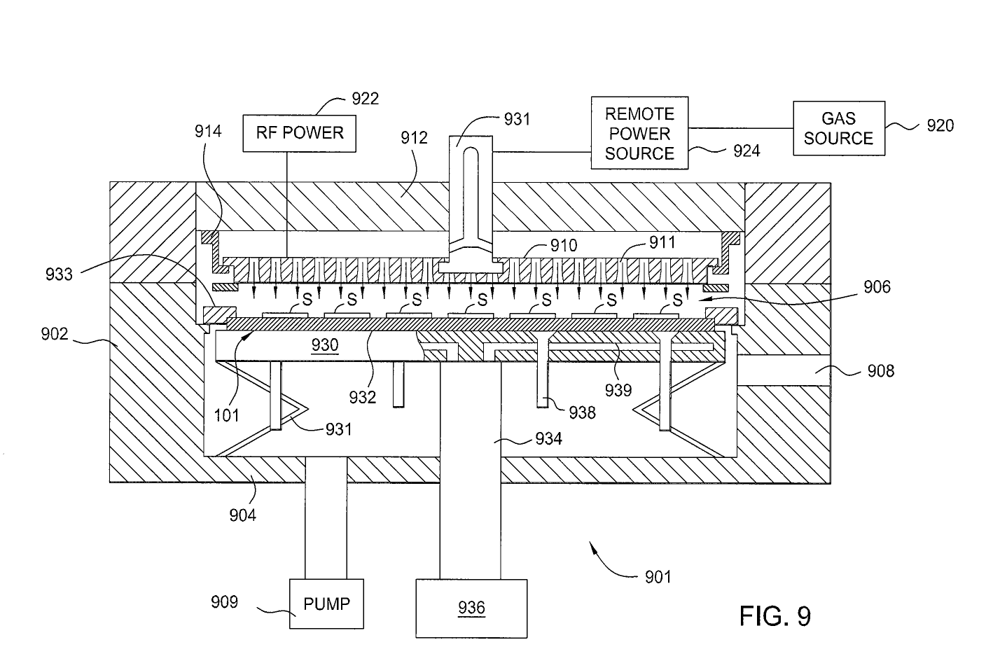

FIG. 1 is schematic plan view of one embodiment of a substrate processing system 100 that includes six processing chambers (e.g., reference numerals 103-108), a load lock chamber 102, and a substrate carrier transfer robot 111 disposed within the transferring region 110C of the transfer chamber 110. In one configuration, the processing chambers 103-108 are selected from a physical vapor deposition (PVD) chamber, a plasma enhanced chemical vapor deposition (PECVD) chamber, a low pressure chemical vapor deposition (LPCVD) chamber, a hot wire chemical vapor deposition (HWCVD) chamber, a plasma nitridation chamber (DPN), a ion implant/doping chamber, an atomic layer deposition (ALD) chamber, a plasma etching chamber, a laser anneal chamber, a rapid thermal oxidation/nitridation (RTO/N) chamber, a rapid thermal annealing (RTA) chamber, a substrate reorientation chamber (e.g., flipping chamber), a vapor etching chamber, a forming gas or hydrogen annealing chamber, and/or a plasma cleaning chamber. According to one embodiment of the invention, the substrate processing system 100 includes a first process chamber 103 and a second process chamber 108 (e.g., FIGS. 1 and 3). In one embodiment, the first process chamber 103 is configured to deposit a specific type of film, and the second process chamber 108 is configured to form a different type of film(s) on a substrate surface. For example, the first process chamber 103 can be used to process one or more silicon-containing films and the second process chamber 108 can be used to process one or more metal-containing films to form a high quality solar cell junction. An example of an exemplary PECVD type processing chamber that may be one or more of the processing chambers 103-108 as well as exemplary processes that may be performed are illustrated and subsequently discussed in conjunction with FIG. 9.

FIGS. 1 and 3 illustrate embodiments of the substrate processing system 100 that are adapted to transfer and process a plurality of solar cell substrates, hereafter substrates “S” arranged in planar arrays, or batches, within the processing system 100. In one embodiment, each substrate transport interface 150 as well as each transfer chamber 110 may include a substrate carrier transfer robot 111 having an end effector 112 to facilitate transfer of a batch of substrates S through the processing system 100 as described herein. In one embodiment, the processing system 100 is adapted to transfer and process a batch of substrates S that are positioned in a planar array on a carrier 101 by moving in both vertical and horizontal directions. In one embodiment, the carrier 101 is adapted to hold and retain the substrates S during the various transportation and processing steps performed on the substrates S within the processing system 100. In this configuration multiple substrates S are transferred, supported, and processed simultaneously to improve the system throughput, reduce the number of required transferring steps, and improve the cost of ownership associated with processing and forming a solar cell device.

FIG. 2 illustrates a plan view of one embodiment of the carrier 101 that is adapted to retain 30 substrates S on the carrier 101. In one configuration, the carrier 101 has a plurality of substrate supporting recesses 101A formed in the carrier 101 to support and laterally retain the substrates S during the movement of the carrier 101 through the substrate processing system 100. In one embodiment, the carrier 101 is adapted to hold at least about 10 substrates S at a time in a planar array. In one embodiment, the carrier 101 is adapted to hold between about 30 and about 80 substrates S at a time in a planar array. In one embodiment, the carrier 101 is adapted to hold greater than 80 substrates S at a time in a planar array. In one configuration the recesses 101A formed in the surface of the carrier 101 have lateral dimensions that are less than about 1 mm larger than the dimensions of the substrate S and have a depth from about 0.1 mm to about 0.3 mm. For example, a solar cell substrate S may have dimensions 156 mm×156 mm×0.2 mm, and the recesses 101A may have corresponding dimensions 158 mm×158 mm×0.3 mm. In another embodiment, the carrier 101 may be a flat carrier without recesses. The carrier 101 may include pins or bosses extending therefrom to retain the substrates S thereon. In one embodiment, the carrier 101 is made of a carbon fiber composite material with a protective coating, such as silicon carbide, formed thereon.

Referring to FIGS. 1 and 3, the processing system 100 may be configured to receive unprocessed substrates S into the substrate transport interface 150 from an upstream location (e.g., an upstream processing module in a solar cell fabrication line) and transport processed substrates S out of the substrate transport interface 150 to a downstream location (e.g., a downstream processing module in a solar cell fabrication line). In general, the substrate transport interface 150, depicted in FIGS. 1 and 3, includes a substrate transfer module 153, a substrate interface module 155, and a substrate transfer module 157.

In operation, an empty substrate carrier 101 is generally loaded with unprocessed substrates S in the substrate transfer module 153. In one embodiment, the substrates S are transported to the substrate transport interface 150 via one or more modular conveyors 123.

In the embodiment depicted in FIG. 1, a modular conveyor 123A is positioned on each side of the substrate transport interface 150 for transporting unprocessed substrates S to the substrate transfer module 153 from an upstream location. Additionally, a modular conveyor 123B is positioned on each side of the substrate transport interface 150 for receiving processed substrates S from the substrate transfer module 157 for transportation to a downstream location. In the embodiment depicted in FIG. 3, a single modular conveyor 123 is positioned to transport unprocessed substrates S for loading into the substrate transfer module 153 and to receive processed substrates S from the unloading module 157 for transportation to a downstream location.

The substrates S may be transported on the modular conveyors 123 individually or in batches, such as in cassettes or stack boxes. In one embodiment, the substrates S are removed from the modular conveyor 123 or 123A and transferred into a receiving area 124 in preparation for loading the substrates S onto a carrier 101 positioned in the substrate transfer module 153. In one embodiment, the substrate transfer module 153 includes one or more substrate transfer robots 122A for transferring the substrates S from the receiving area 124 into a desired position on the substrate carrier 101. In one embodiment, the substrate transfer robots 122A may be SCARA, six-axis, parallel, or linear type robots that can be adapted to transfer substrates from one position within the processing system 100 to another. In one example, the substrate transfer robots 122A are Quattro Parallel Robots that are available from Adept Technology, Inc. of Pleasanton, Calif.

In the case of stack boxes or cassettes, once the substrates S are unloaded from the respective stack box or cassette, the empty stack box or cassette is returned to the modular conveyor 123 or 123A for transport either back upstream (FIG. 1) or downstream (FIG. 3) for further use.

In one embodiment, after filling up the carrier 101 with substrates S, the carrier 101 is transferred into the substrate interface module 155 via a substrate carrier transfer robot 109 located in the substrate interface module 155. In one embodiment, the substrate carrier transfer robot 109 has an end effector 113 configured to retrieve the substrate carrier 101 from the substrate transfer module 153 and transfer the substrate carrier 101 into the load lock chamber 102. In one embodiment, the substrate carrier transfer robot 109 is further configured to retrieve the substrate carrier 101 from the load lock chamber 102 and transfer the substrate carrier into the substrate transfer module 157. In one embodiment the substrate carrier transfer robot 109 is configured to move the substrate carrier 101 vertically as well as horizontally. In one embodiment, the substrate carrier transfer robot 109 is similar to the substrate carrier transfer robot 111. In another embodiment, the substrate carrier transfer robot 111 incorporates a conveyor mechanism coupled to lift and rotate mechanisms.

It should be noted that not all regions of the carrier 101 need to be filled during processing. For example, a substrate S may have been broken in an earlier process. In some cases, a partial batch of substrates S may be intentionally processed within the processing system 100. In some cases, when a partial batch of substrates S are to be processed, it may be desirable to insert one or more dummy substrates within a batch of substrates S to minimize the exposure of the chamber components (e.g., susceptor) directly to the processing environment.

In one example, the load lock chamber 102 comprises a plurality of isolatable regions (e.g., substrate sub-chambers 820, 822, 824 illustrated in FIG. 8) that allow the unimpeded movement of multiple substrate carriers 101 and/or substrates S into and out-of the load lock chamber 102 from the transfer chamber 110 or the substrate interface module 155. An example of an exemplary load lock chamber 102 having a plurality of isolatable regions is illustrated and subsequently discussed in conjunction with FIG. 8.

After receiving the substrate carrier 101 and the substrates S into a region of the load lock chamber 102, such as sub-chamber 820 (FIG. 8), the sub-chamber 820 is closed and pumped down to a desired pressure using a vacuum pump (not shown). After achieving a desired pressure in the sub-chamber 820, the substrate carrier 101 and the substrates S are then received by the end effector 112 of the substrate carrier transfer robot 111 contained in the transfer chamber 110. The substrate carrier transfer robot 111 may then transfer the substrate carrier 101 and the substrates S into one of the processing chambers, such as processing chamber 103. In one example, a PECVD amorphous silicon deposition process is then performed on the substrates S positioned in the processing chamber 103.

In one embodiment, the substrates S are crystalline silicon substrates having p-type base regions. A mixture of gases including silicon-containing compounds, such as silane (SiH₄), disilane (Si₂H₆), tetrafluorosilane (SiF₄), or other silicon-containing compounds useful for depositing a layer of amorphous silicon directly onto a surface of the crystalline silicon substrates S. An n-type precursor, such as phosphine (PH₃) is delivered to the processing chamber along with the silicon-containing compounds in order to provide an n-doped amorphous silicon film layer deposited on the substrates S from the gas mixture. In one embodiment, the doped amorphous silicon film is deposited at a film thickness from about 100 Å to about 1000 Å.

After performing a desired solar cell formation process on the substrates S, the substrate carrier 101 and the substrates S are then transferred by the substrate carrier transfer robot 111 into another processing chamber, such as the processing chamber 104. In one example, a passivation layer deposition process is performed on the substrates S positioned in the processing chamber 104. An example of such a passivation layer process is subsequently described below in the section entitled, “Passivation Layer Deposition.”

In one embodiment, the processing system 100 may further include a processing chamber for reorienting, or flipping, the substrates S, such as the processing chamber 105. In such an embodiment, the substrates S, having been processed on one side, may then be transferred into the processing chamber 105 for reorienting the substrates S such that the opposite side may be processed. For instance, if an upwardly facing side of each substrate is first processed, the processing chamber 105 reorients each of the substrates S such that the previously upwardly facing side faces downwardly and the previously downwardly facing side faces upwardly for subsequent processing. After reorienting the substrates S, the substrates S may then be transferred into subsequent processing chambers, such as processing chambers 106, 107, or 108 for processing the opposite side of the substrates S prior to transfer back into the load lock chamber 102. In one embodiment, the substrates S are transferred into processing chamber 106, such as a PVD chamber, and a metallization type deposition process is performed on the substrates S. Thus, processing of a first side of the substrates S, flipping of the substrates S, and processing of the opposite side of the substrates S may all be achieved within the processing system 100 without breaking vacuum within the system. In one embodiment, a metallization type deposition process is performed on the substrates S

After performing desired solar cell formation processes on the substrates S, the substrate carrier 101 and the substrates S are then transferred by the substrate carrier transfer robot 111 from the transfer chamber 110 to a region of the load lock chamber 102, such as sub-chamber 822 (FIG. 8). After achieving a desired pressure in the sub-chamber 822, the substrate carrier 101 and the substrates S are then retrieved from the load lock chamber 102 by the substrate carrier transfer robot 109 within the substrate interface module 155. Once the substrates S are transferred back into the substrate interface module 155, the substrate carrier 101 and the substrates S are transported into the substrate transfer module 157 via substrate carrier transfer robot 109 for unloading the individual substrates S from the substrate transfer interface 150. In one embodiment, each of the substrates S are then transferred from the substrate transfer module 157 to the substrate exit area 126 via one or more substrate transfer robots 122B contained in the substrate transfer module 157. After the substrates S are positioned in the exit area 126, the empty substrate carrier 101 may be stored, cleaned, and/or transported back into the substrate transfer module 153.

After positioning the substrates S in the exit area 126, the substrates S are then transferred to the modular conveyor 123 or 123B where the processed substrates S are transported to downstream process modules in the solar cell fabrication facility. This configuration may be used to allow one or both sides of a solar cell substrate to be processed in a vacuum or inert environment without exposure to atmospheric contaminants.

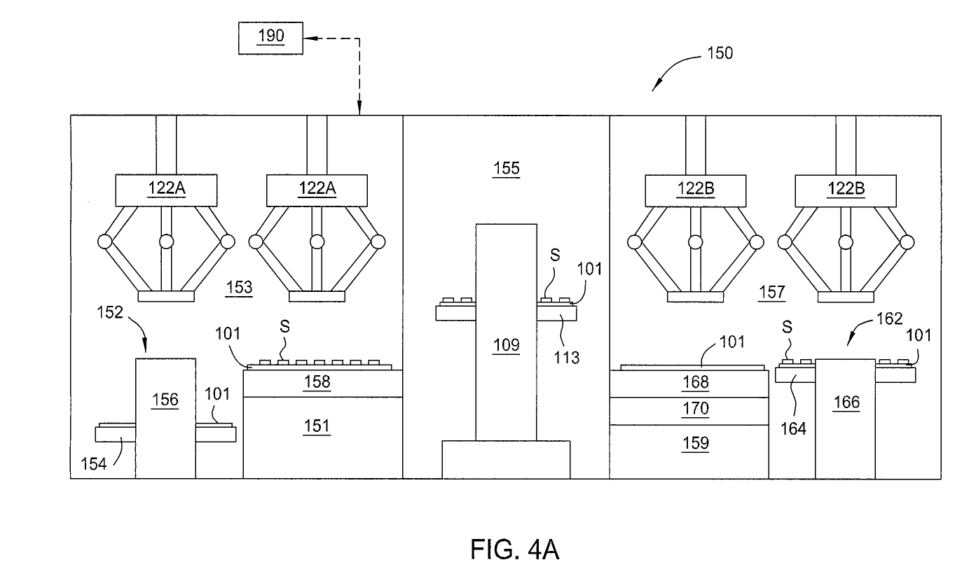

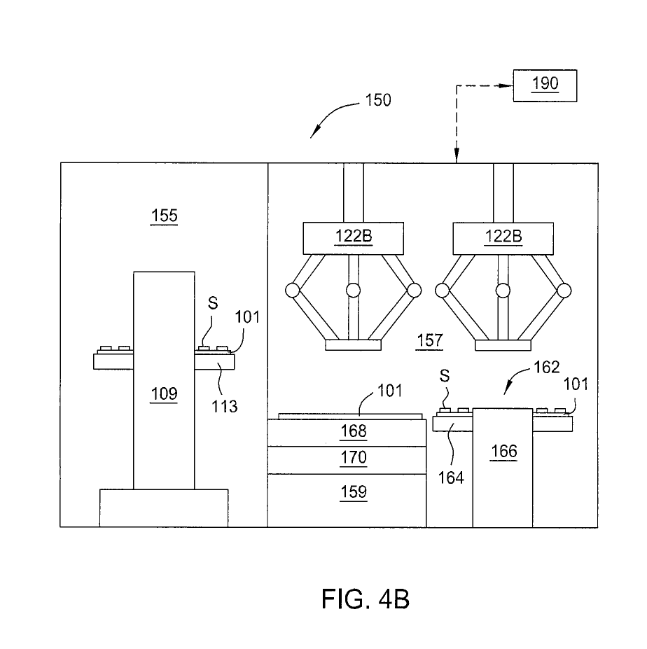

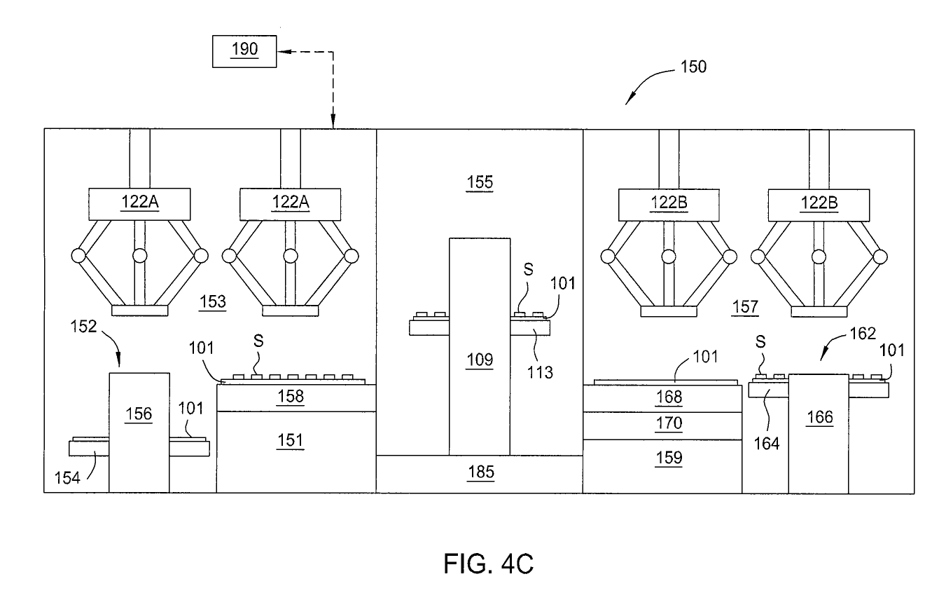

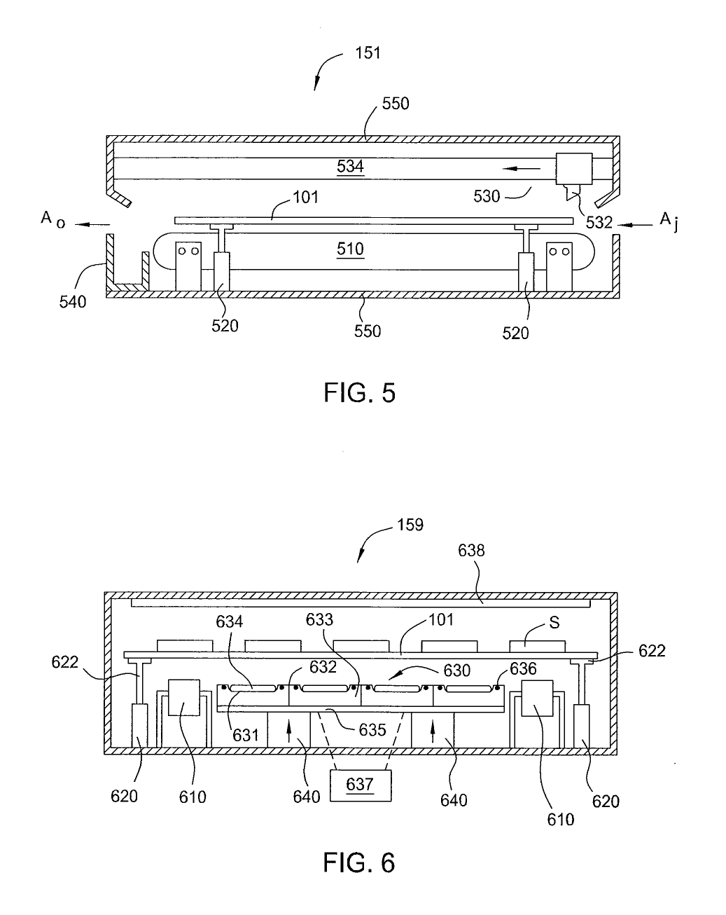

It should be noted that the number of transferring steps and processing steps discussed herein are not intended to limit the scope of the invention and can vary in the number of processes performed on the solar cell substrate S, vary in the number of processing chambers that are used to from a solar cell, and vary in the order and sequence of processes without deviating from the basic scope of the invention disclosed herein. For example, the processing system 100 may include only a single processing chamber 103 rather than the plurality of processing chambers 103-108 coupled to the load lock chamber 102 via the transfer chamber 110. In such a configuration, the single processing chamber 103 is coupled to the load lock chamber 102 with or without the need for the transfer chamber 110 and the substrate carrier transfer robot 111. The load lock chamber 102 may include a substrate carrier transport means, such as a conveyor mechanism similar to carrier conveyors subsequently described herein with respect to FIGS. 4A-4C and 5.

FIG. 4A is a schematic front view of a substrate transport interface 150 according to one embodiment of the present invention. As previously described, the substrate transport interface 150 generally includes the substrate transfer module 153 where substrates S are loaded onto a substrate carrier 101, the substrate interface module 155 having a substrate carrier transfer robot 109 that transfers the substrate carriers 101, and the substrate transfer module 157 where substrates S are unloaded from the substrate carrier 101.

In another embodiment, schematically depicted in FIG. 4B, the functions of loading substrates S onto and unloading the substrates S off of the substrate carrier 101 are both performed in a single substrate transfer module, such as the transfer module 157. In such an embodiment, the substrate transfer module 157 is used both for loading and unloading substrates S onto and off of the substrate carrier 101 using one or more of the substrate transfer robots 122B. As such, the exit area 126, shown in FIG. 3, is used both as a receiving area and as an exit area as previously described. In yet another embodiment, loading and unloading of substrates S the substrate carrier 101 may be performed while the substrate carrier 101 is positioned on the substrate carrier transfer robot 111.

In one embodiment, the substrate transfer module 153 includes a cleaning module 151 that receives and cleans a substrate carrier 101. In one embodiment, the substrate carrier transfer robot 109 located in the substrate interface module 155 retrieves an empty substrate carrier 101 from the substrate transfer module 157 and transfers the empty substrate carrier 101 into the cleaning module 151. In another embodiment, an empty substrate carrier 101 is transported from the substrate transfer module 157 into the cleaning module 151 via a modular conveyor 185, which links the substrate transfer module 157 with the substrate transfer module 153 as shown in FIG. 4C. In one example, it is generally desirable to clean the substrate carriers 101 prior to loading unprocessed substrates S onto the substrate carriers 101 in order to ensure that no debris impedes proper positioning of the substrates Son the substrate carriers 101.

FIG. 5 is a schematic, front, cross-sectional view of a cleaning module 151 according to one embodiment of the present invention. The cleaning module 151 generally includes a carrier conveyor 510, lift mechanisms 520, a cleaning mechanism 530, a waste bin 540, and an enclosure 550. In one embodiment, an empty substrate carrier 101 is received onto the carrier conveyor 510 from the substrate carrier transfer robot 109 in an inlet direction Ai. The carrier conveyor 510 may include one or more rollers, belts, and actuators controlled by the system controller 190 for advancing the substrate carrier 101. In one embodiment, sensors, such as capacitive sensors, detect the presence of the substrate carrier 101 on the carrier conveyor 510 and send signals to the system controller 190. The system controller 190, in turn, sends signals to actuate the lift mechanisms 520.

In one embodiment, the lift mechanisms 520 are a plurality of cylinders (e.g., pneumatic cylinders) positioned about the carrier conveyor 510. The lift mechanisms 520 are configured to contact the lower surface of the substrate carrier 101 and raise the substrate carrier 101 to a cleaning position. Once the substrate carrier 101 is in the cleaning position as sensed by sensors, such as inductive sensors, the system controller 190 sends signals to the cleaning mechanism 530 to clean the substrate carrier 101.

In one embodiment, the cleaning mechanism 530 includes a debris removal device 532 attached to a linear actuator 534 (e.g., a rodless pneumatic cylinder). The debris removal device 532 is configured to span the width of the substrate carrier 101, and the linear actuator 534 is configured to horizontally move the debris removal device 532 the length of the substrate carrier 101. In one embodiment, the debris removal device 532 is a compressed air device (e.g., an air knife). In this embodiment, once the substrate carrier 101 is in its raised cleaning position, a curtain of compressed air is blown onto the substrate carrier 101 across the entire width of the substrate carrier 101 via the debris removal device 532. In another embodiment, the debris removal device 532 is a vacuum device configured to lift and remove debris from the substrate carrier 101. The debris removal device 532 is then moved down the entire length of the substrate carrier 101 via the linear actuator 534 in order to remove any debris from the substrate carrier 101. The debris removed from the substrate carrier 101 is blown or transported into the waste bin 540 positioned at the end of the carrier conveyor 510 for subsequent removal. Once the debris removal device 532 has moved along the entire length of the substrate carrier 101, and the substrate carrier 101 is clean, the linear actuator 534 returns the debris removal device 532 to its starting position. In one embodiment, the lift mechanisms 520 are configured to tip the substrate carrier 101 to aid in the debris removal process.

In one embodiment, after the substrate carrier 101 has been cleaned by the cleaning mechanism 530, the substrate carrier 101 is lowered back onto the carrier conveyor 510 via the lift mechanisms 520. The clean substrate carrier 101 may then be removed from the cleaning module 151 by use of the carrier conveyor 510 in an outlet direction Ao.

In one embodiment, the enclosure 550 is configured to retain debris within the cleaning module 151 and direct the debris into the waste bin 540 during cleaning of the substrate carrier 101. The enclosure 550 is further configured to maintain steady state pressure within the cleaning module 151 during the cleaning process. In one embodiment, the enclosure 550 is a sheet metal structure that supports and encloses components of the cleaning module 151.

Referring to FIG. 4A, the substrate transfer module 153 may further include a lift module 152 for receiving the clean substrate carrier 101 from the cleaning module 151 and raising the substrate carrier 101 for loading with substrates S. In one embodiment, the clean substrate carrier 101 is transported from the carrier conveyor 510 within the cleaning module 151 onto a carrier conveyor 154 within the lift module 152 through the use of the respective carrier conveyors 510, 154. In one embodiment, the carrier conveyor 154 is similar to the carrier conveyor 510, which includes one or more rollers, belts, and actuators controlled by the system controller 190 for advancing the substrate carrier 101.

In one embodiment, the lift module 152 further includes a lift, or elevator mechanism 156 for raising and lowering the carrier conveyor 154. In one embodiment, the elevator mechanism 156 comprises one or more linear actuators, such as pneumatic, electric, or hydraulic cylinders or motors. Generally, the clean substrate carrier 101 is received into the lift module 152 at a lower level (i.e., in-line with the cleaning module 151) and is raised to an upper level via the elevator mechanism 156 controlled by the system controller 190. Substrates S are loaded onto the clean substrate carrier 101 at the upper level.

In one embodiment, the clean substrate carrier 101 is then advanced onto a carrier conveyor 158, which is similar to the carrier conveyor 154 via the respective carrier conveyors 154, 158 controlled by the system controller 190. In one embodiment, the clean substrate carrier 101 is fully loaded with substrates S while it is situated on the carrier conveyor 154. In one embodiment, the clean substrate carrier 101 is fully loaded with substrates S after it is transferred to the carrier conveyor 158. In one embodiment, the substrate carrier 101 is partially loaded while situated on the carrier conveyor 154 and partially loaded while situated on the carrier conveyor 154 to increase throughput of the overall system 100.

After the clean substrate carrier 101 is fully loaded with substrates S, the substrate carrier transfer robot 109 transfers the fully loaded substrate carrier 101 into the load lock 102 as previously described. After the substrates S on the substrate carrier 101 have been processed, the substrate carrier transfer robot 109 transfers the substrate carrier 101 from the load lock 102 into the unloading module 157.

In one embodiment, the substrate transfer module 157 includes a cooling module 159 that receives and cools a substrate carrier 101 having processed substrates S positioned thereon. In this embodiment, the substrate carrier transfer robot 109, located in the substrate interface module 155 and controlled by the system controller 190, retrieves the substrate carrier 101 loaded with processed substrates S directly from the load lock 102 and transfers the fully loaded substrate carrier 101 into the cooling module 159. In another embodiment, as shown in FIG. 4C, the substrates S are unloaded from the substrate carrier 101 in the substrate transfer module 157 prior to transporting the substrate carrier 101 into the cooling module 159. In this embodiment, the substrate carrier transfer robot 109 transfers the substrate carrier 101 into the substrate transfer module 157 for substrate removal, and the empty substrate carrier 101 is transferred into the cooling module 159 via a modular conveyor in a direction opposite to that subsequently described. In one example, it is generally desirable to cool the substrate carrier 101 with or without the processed substrates S thereon from a temperature of at least about 350° C. to a temperature at or below about 70° C. to prevent excessive native oxide growth on the substrates S, which leads to low efficiency solar cells.

FIG. 6 is a schematic, side, cross-sectional view of a cooling module 159 according to one embodiment of the present invention. The cooling module 159 generally includes a carrier conveyor 610, carrier lift mechanisms 620, a cooling plate 630, and a cooling plate actuator 640. In one embodiment, a substrate carrier 101 loaded with processed substrates S is placed onto the extended carrier lift mechanisms 620 via the substrate carrier transfer robot 109. In one embodiment, the carrier lift mechanisms 620 are a plurality pneumatically actuated (e.g., pneumatic cylinders) lift pins 622 positioned about the carrier conveyor 610 and configured to receive the substrate carrier 101 in their extended (i.e., elevated) position. Once the substrate carrier 101 is received onto the lift mechanisms 620, the system controller 190 signals the lift mechanisms 620 to lower the substrate carrier 101 onto an upper surface of the cooling plate 630.

In one embodiment, the cooling plate 630 is a plate having a base 632 made of a conductive material (e.g., aluminum) with cooling tubing 634 (e.g., copper tubing) in conductive contact therewith. In one embodiment, the base 632 is a single block of conductive material. In one embodiment, the base 632 is a plurality of blocks 633 of conductive material supported on a lower surface by one or more support plates 635 attached thereto. In one embodiment, the cooling tubing 634 is routed in a serpentine path and positioned within grooves 631 formed in the base 632. In one embodiment, the cooling tubing 634 is configured to flow a cooling fluid therethrough for cooling the base 632, and ultimately, the substrate carrier 101 and processed substrates S. The cooling fluid may be chilled water (e.g., about 15° C. to about 20° C.) or other suitable cooling fluid.

In one embodiment, the cooling plate 630 is supported by the cooling plate actuator 640. The cooling plate 630 may receive the carrier support 101 from the lift mechanisms 620 in an extended or upper position. The cooling plate actuator 640 may be one or more pneumatic cylinders positioned beneath the cooling plate 630 and controlled by the system controller 190 to raise and lower the cooling plate 630.

In one embodiment, the cooling plate 630 has a plurality of ports 636 disposed therein, which are fluidly connected to a vacuum pump 637 for pulling the substrate carrier 101 tightly against the cooling plate 630 to aid in the cooling process. In another embodiment, the cooling module 159 includes a forced air device 638 in lieu of or in addition to the cooling plate 630 to aid in cooling the substrate carrier 101.

Once the carrier support 101 and substrates S thereon have been cooled by the cooling plate 630, the cooling plate actuator 640, controlled by the system controller 190, lowers the cooling plate 630 to place the substrate carrier 101 onto the carrier conveyor 610. The carrier conveyor 610 may include one or more rollers, belts, and actuators controlled by the system controller 190 to advance the substrate carrier 101 out of the cooling module 159. It should be understood that the carrier conveyor 610 is configured to advance the substrate carrier 101 into or out of the page as schematically depicted in FIG. 6.

Referring back to FIGS. 4A and 4B, the unloading module 157 may further include a lift module 162 for receiving the cooled substrate carrier 101 and substrates S from the cooling module 159 and raising the substrate carrier 101 for unloading the substrates S. In one embodiment, the cooled substrate carrier 101 is transported from the carrier conveyor 610 within the cooling module 159 onto a carrier conveyor 164 within the lift module 162 through the use of the respective carrier conveyors 610, 164. In one embodiment, the carrier conveyor 164 is similar to the carrier conveyor 610, which includes one or more rollers, belts, and actuation devices controlled by the system controller 190.

In one embodiment, the lift module 162 further includes a lift, or elevator mechanism 166 for reading and lowering the carrier conveyor 164. In one embodiment, the elevator mechanism 166 comprises one or more linear actuators, such as pneumatic, electric, or hydraulic cylinders or motors. Generally, the cooled substrate carrier 101 is received into the lift module 162 at a lower level (i.e., in-line with the cooling module 159) and is raised to an upper level via the elevator mechanism 166 wherein substrate S are unloaded from the cooled substrate carrier 101.

In one embodiment, the cooled substrate carrier 101 is then advanced onto a carrier conveyor 168, which is similar to the carrier conveyor 164 via the respective carrier conveyors 164, 168 controlled by the system controller 190. In one embodiment, the cooled substrate carrier 101 is fully unloaded while it is situated on the carrier conveyor 164. In one embodiment, the cooled substrate carrier 101 is fully unloaded after it is transferred to the carrier conveyor 168. In one embodiment the cooled substrate carrier 101 is partially unloaded while situated on the carrier conveyor 164 and partially unloaded while situated on the carrier conveyor 164 to increase throughput of the overall system 100. In one embodiment, shown in FIG. 4B, the empty substrate carrier 101 is then loaded with substrates S on one or more of the respective carrier conveyors 164, 168 via one or more of the substrate transfer robots 123B.

In one embodiment, the substrate transfer module 157 further includes a buffering module 170 to provide spacing for storage and staging of one or more additional substrate carriers 101. In one example, it may be desirable to store one or more additional substrate carriers 101 within the unloading module 157 in order to provide a ready supply of substrate carriers 101 into the system 100. In another example, it may be desirable to provide a collection area where one or more substrate carriers 101 may be stored within the system 100 if any of the components of the system 100 go down. Generally, the addition of the buffering module 170 allows optimized utilization of the system 100 during fault induced line stoppages. Incorporation of such a module into the substrate transfer module 157 maximizes efficiency of the overall system 100 while minimizing the overall footprint requirements. In one embodiment, the buffering module 170 is located above the cooling module as shown in FIG. 4.

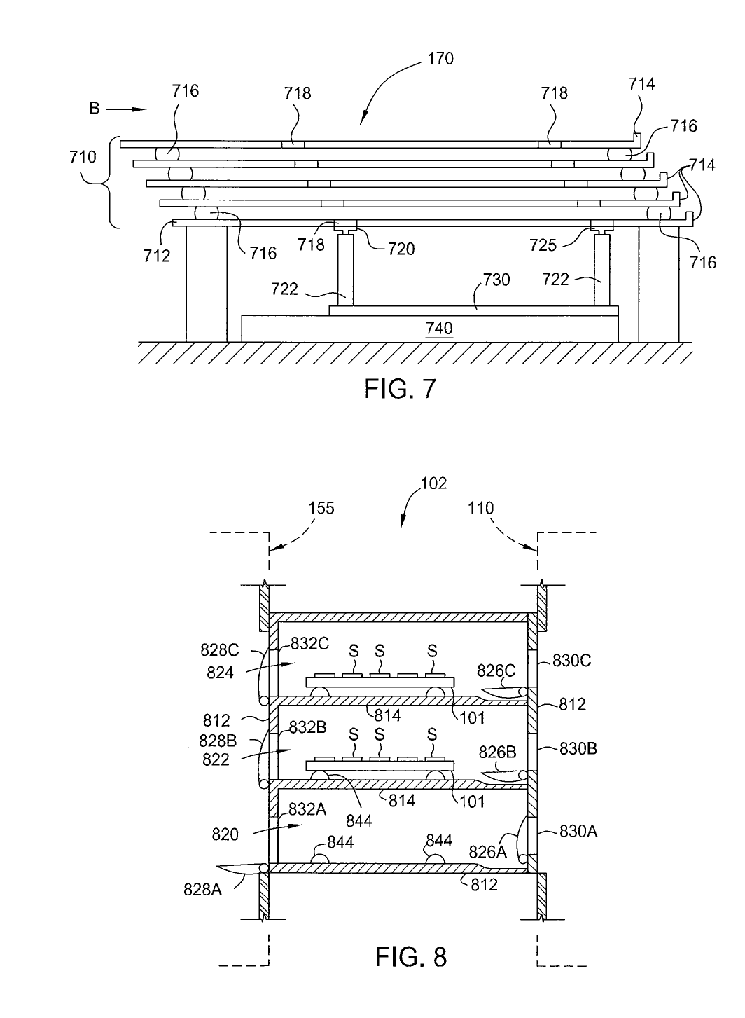

FIG. 7 is a schematic, front view of the buffer module 170 according to one embodiment of the present invention. In one embodiment, the buffer module 170 includes a plurality of shelves 710 for storing one or more substrate carriers 101, a plurality of lifting pins 720 for raising and lowering one or more of the shelves 710, a base plate 730 for supporting the plurality of lifting pins 720, and a linear actuator 740 for laterally moving the base plate 730.

In one embodiment, the plurality of shelves 710 includes one or more stationary base shelves 712 and one or more vertically movable shelves 714. In one embodiment, the plurality of shelves includes ten or more vertically movable shelves 714. In one embodiment, one or more spacers 716 are positioned between each of the shelves 712, 714 in order to provide sufficient vertical spacing between the shelves 712, 714 to allow for a substrate carrier 101 to rest on each shelf 712, 714. In one embodiment, the spacers 716 provide at least about 6 mm of spacing between each shelf 712, 714. In another embodiment, instead of spacers 716, the shelves 712, 714 are spaced apart by supportive brackets having staggered supports extending therefrom to support each of the shelves 712, 714. In this embodiment, the shelves 712, 714 may have staggered cutouts to allow the shelves 712, 714 to be raised above the supports respectively positioned thereabove. Each of the shelves 712, 714 may also be laterally spaced apart as shown in FIG. 7. In one embodiment, each of the shelves 712, 714 are laterally spaced apart to provide at least about 20 mm lateral spacing between each shelf 712, 714. In one embodiment, each of the vertical moveable shelves 714 have one or more staggered features 718 for supporting contact from the lifting pins 720 during lifting operations as subsequently described. In one embodiment, the staggered features 718 are tabs extending outwardly from the vertically moveable shelves 714.

In one embodiment, each of the lifting pins 720 is positioned on the base plate 730. Each lifting pin 720 may include a pneumatic cylinder 722 controlled by the system controller 190 for raising and lowering the lifting pin 720. The base plate 730 is, in turn, coupled to the linear actuator 740. The linear actuator 740 may be servomotor driven and controlled by the system controller 190.

In operation, a substrate carrier 101 may be individually loaded onto each of the plurality of shelves 710 via the substrate carrier transfer robot 109 controlled by the system controller 190. In one embodiment, the shelves 714, positioned above the shelf 712, 714 on which the substrate carrier 101 is to be placed, are collectively raised in order to provide spacing for the end effector 113 of the robot 109 to position the substrate carrier 101 therein.

For instance, in order to load a first substrate carrier 101 onto the stationary base shelf 712, the linear actuator 740 first laterally positions the base plate 730 such that the lift pins 710 are aligned with the features 718 of the lowest vertically movable shelf 714. The lift pins 710 are then actuated to extend contacting the features of the lowest vertically movable shelf 714, and raising the lowest vertically movable shelf 714 along with each shelf positioned thereabove. As a result, a spacing (e.g., at least about 110 mm) is provided between the stationary base shelf 712 and the lowest vertically movable shelf 714 to allow for placement of the first substrate carrier 101 onto the stationary base shelf 712 via the substrate carrier transfer robot 109. Next, in order to load a second substrate carrier 101 onto the lowest vertically movable shelf 714, the linear actuator 740 positions the base plate 730 such that the lift pins 710 are aligned with the features 718 of the second lowest vertically movable shelf 714. The lift pins 710 are then actuated to lift the second lowest vertically movable shelf 714 along with each shelf positioned thereabove to provide sufficient spacing between the lowest vertically movable shelf 714 and the second lowest vertically movable shelf 714 to allow for placement of the second substrate carrier 101 onto the lowest vertically movable shelf 714. The operations may be repeated until all of the buffer shelves 710 are loaded with substrate carriers 101. As needed, the substrate carriers 101 may be subsequently unloaded by essentially reversing the above operations. As such, the loading and unloading of substrate carriers 101 on the buffer shelves 710 are carried out using first-in, last-out logic.

In another embodiment, the buffer module 170 includes only a plurality of the stationary shelves 712 spaced apart adequately to receive a substrate carrier 101 on each shelf. In one embodiment, substrate carriers 101 having processed substrates S thereon may be transferred from the load lock chamber 102 into the buffer module 170 for a timed cooling sequence controlled by the system controller 190. Once the timed cooling sequence is completed the substrate carrier 101 is transported onto the carrier conveyor 168 and/or 164 for unloading of the substrates S. In another embodiment, the substrate carrier 101 is first unloaded and then transferred into the buffer module 170 for a timed cooling sequence controlled by the system controller 190. In one embodiment, the system controller 190 is used to track each substrate carrier 101 throughout the entire system. In this embodiment, the system controller 190 is configured to not only keep track of the processing sequences, but it is also configured to keep track of empty substrate carriers 101 disposed in various locations throughout the system. In this embodiment, buffering of substrate carriers 101 during system ramp up or ramp down may be accomplished by tracking the transfer of empty substrate carriers 101 throughout the system rather than storing the empty substrate carriers 101 in the buffer module 170.

### Load Lock Chambers

FIG. 8 is a cross-sectional view of one embodiment of the load lock chamber 102. The load lock chamber 102 may include a plurality of single substrate transfer compartments/sub-chambers as shown in FIG. 8, or alternatively one or more transfer compartments/sub-chambers, each sub-chamber for loading and unloading multiple substrates. Load lock chambers that may be adapted to benefit from the invention are described in commonly assigned U.S. patent application Ser. No. 09/663,862 filed on Sep. 15, 2000, by Kurita et al.; Ser. No. 09/957,784, entitled “Double Dual Slot Load Lock for Process Equipment”, filed Sep. 21, 2001 by Kurita et al. and issued on Mar. 21, 2002 as U.S. Pat. Nos. 7,105,463; and 10/832,795, entitled “Load Lock Chamber for Large Area Substrate Processing System”, filed Apr. 26, 2004 by Kurita et al. and issued on Apr. 24, 2007 as U.S. Pat. No. 7,207,766, all of which are hereby incorporated by reference in their entireties.

The load lock chamber 102 may include a chamber body 812 with a plurality of vertically-stacked, environmentally-isolated, single substrate sub-chambers 820, 822, 824 separated by a plurality of vacuum-tight, horizontal interior walls 814. Two of the interior walls 814 are shown in FIG. 8. Although three single substrate sub-chambers 820, 822, 824 are shown in the embodiment depicted in FIG. 8, it is contemplated that the chamber body 812 of the load lock chamber 102 of the invention may include just one load lock chamber or two or more vertically-stacked substrate load lock sub-chambers. For example, the load lock chamber 102 may include N substrate sub-chambers separated by N-1 horizontal interior walls 814, where N is an integer number.

In the embodiment depicted in FIG. 8, the substrate sub-chambers 820, 822, 824 are each configured to accommodate a single batch of substrates S, such as a plurality of substrates S disposed on the substrate carrier 101 (FIG. 2), so that the volume of each chamber may be minimized to enhance fast pumping and vent cycles. It is contemplated that load lock chambers or sub-chambers of the invention may be configured to accommodate even larger batches of substrates.

The chamber body 812 can be fabricated from a rigid material suitable for use under vacuum conditions, such as stainless steel or aluminum. The horizontal walls 814 of the chamber body 812 may be vacuum sealed to sidewalls of the chamber body 812, thereby isolating the substrate sub-chambers 820, 822, 824. For example, the horizontal walls 814 assembled into the load lock chamber 102 may be continuously welded to the chamber body 812 to allow greater access to the entire interior of the chamber body 812.

Generally, each of the substrate sub-chambers 820, 822, 824 defined in the chamber body 812 includes two substrate access ports. For example, in FIG. 8, the first substrate sub-chamber 820 disposed at the bottom of the chamber body 812 includes a first substrate access port 830A and a second substrate access port 832A coupled to the transfer chamber 110 (FIG. 1) and the substrate interface module 155, respectively. The two access ports may be positioned, for example, on opposite sides of the chamber sidewalls. The substrate access ports are configured to facilitate the entry and egress of the substrates from the load lock chamber 102. Similarly, the substrate sub-chamber 822 is configured with access ports 830B, 832B and the substrate sub-chamber 824 is similarly configured with access ports 830C, 832C. Each of the substrate access ports 830A, 830B, 830C, 1132A, 832B, 832C is selectively sealed by a respective slit valve 826A, 826B, 826C, 828A, 828B, 828C that is adapted to selectively isolate the substrate sub-chambers 820, 822, 824 from the environments of the transfer chamber 110 and the substrate interface module 155. The slit valves 826A, 826B, 826C, 828A, 828B, 828C are pivotally coupled to the chamber body 812 and may be moved between an open and closed position using an actuator (not shown).

In one configuration, the carriers 101 are supported above the bottom of each of the substrate sub-chambers 820, 822, 824 by a plurality of substrate supports 844, which are configured and spaced at an elevation with the chamber body 812 or the horizontal walls 814.

### Processing Chamber Configuration

FIG. 9 is a schematic cross-section view of one embodiment of a processing chamber, such as a PECVD chamber 901 in which one or more films can be deposited on each of the substrates S in the batch. In one configuration, the PECVD chamber 901 is adapted to deposit one or more layers on each of the substrates S that are disposed on a carrier 101, as shown in FIG. 9. One suitable plasma enhanced chemical vapor deposition chamber is available from Applied Materials, Inc., located in Santa Clara, Calif. It is contemplated that other deposition chambers, such as hot wire chemical vapor deposition (HWCVD), low pressure chemical vapor deposition (LPCVD), physical vapor deposition (PVD), evaporation, or other similar devices, including those from other manufacturers, may be utilized to practice the present invention. In one embodiment, the chamber 901 generally includes walls 902, a bottom 904, and a showerhead 910, and substrate support 930 which define a process volume 906. The process volume is accessed through a valve 908 such that the batch of substrates S, such as a plurality of substrates S disposed on a substrate carrier 101, may be transferred in and out of the PECVD chamber 901. The substrate support 930 includes a substrate receiving surface 932 for supporting substrates S and a stem 934 coupled to a lift system 936 to raise and lower the substrate support 930. A shadow frame 933 may be optionally placed over periphery of the carrier 101 that may already have one or more layers formed thereon. Lift pins 938 are moveably disposed through the substrate support 930 to move the carrier 101, or the plurality of substrates S in a carrier-less system, to and from the substrate receiving surface 932. The substrate support 930 may also include heating and/or cooling elements 939 to maintain the substrate support 930 at a desired temperature.

The showerhead 910 is coupled to a backing plate 912 at its periphery by a suspension 914. A gas source 920 is coupled to the backing plate 912 to provide gas through the backing plate 912 and through the plurality of holes 911 in the showerhead 910 to the substrate receiving surface 932. A vacuum pump 909 is coupled to the PECVD chamber 901 to control the process volume 906 at a desired pressure. An RF power source 922 is coupled to the backing plate 912 and/or to the showerhead 910 to provide RF power to the showerhead 910 so that an electric field is created between the showerhead 910 and the substrate support 930 so that a plasma may be generated from the gases between the showerhead 910 and the substrate support 930. Various RF frequencies may be used, such as a frequency between about 0.3 MHz and about 200 MHz. In one embodiment the RF power source is provided at a frequency of 13.56 MHz. Examples of showerheads are disclosed in U.S. Pat. No. 6,477,980 issued on Nov. 12, 2002 to White et al., U.S. Publication 20050251990 published on Nov. 17, 2006 to Choi et al., and U.S. Publication 2006/0060138 published on Mar. 23, 2006 to Keller et al, which are all incorporated by reference in their entirety to the extent not inconsistent with the present disclosure.

A remote plasma source 924, such as an inductively coupled remote plasma source, may also be coupled between the gas source and the backing plate. Between processing batches of substrates, a cleaning gas may be provided to the remote plasma source 924 so that remote plasma is generated and provided to clean chamber components. The cleaning gas may be further excited by the RF power source 922 provided to the showerhead. Suitable cleaning gases include but are not limited to NF₃, F₂, and SF₆. Examples of remote plasma sources are disclosed in U.S. Pat. No. 5,788,778 issued Aug. 4, 1998 to Shang et al., which is incorporated by reference to the extent not inconsistent with the present disclosure.

### Passivation Layer Deposition

The following examples describe passivation layer deposition processes that may be performed during solar cell formation in one or more of the processing chambers (103-108), such as the processing chamber illustrated and described with respect to FIG. 9. In one embodiment, a process for depositing a hydrogenated SiN layer on solar cell substrates S may be performed using a hydrogen dilution process as follows.

After the substrates S are positioned in the one of the processing chambers 103-108 in the processing system 100, a process gas mixture is flowed into the chamber. The process gas mixture includes a precursor gas mixture and a hydrogen gas (H₂) diluent. The hydrogen gas diluent may have a flow rate as high as approximately two times the flow rate of the precursor gas mixture. The precursor gas mixture may be a combination of silane (SiH₄) and nitrogen (N₂), silane and ammonia (NH₃), or silane, ammonia, and nitrogen. In one example, flow rates for a process gas mixture containing silane, ammonia, and hydrogen may be 3.5 sccm, 50 sccm, and 80 sccm, per liter of chamber volume, respectively. Flow rates for a process gas mixture containing silane, ammonia, nitrogen, and hydrogen may be 5 sccm, 16 sccm, 40 sccm, and 80 sccm, per liter of chamber volume, respectively.

Next, plasma is generated in the processing chamber 103-108 to deposit a SiN layer on the substrates S, wherein the SiN layer is suitable for use as a combined ARC and passivation layer for a solar cell. Namely, the SiN layer so deposited has a mass density of between about 2.6 and 2.8 g/cm³, a refractive index of between about 2.0 and 2.2, and a hydrogen concentration of between about 5 atomic percent and 15 atomic percent. In one embodiment, a chamber pressure of 1.5 Torr may be maintained in the chamber and RF power intensity of 0.54 W/cm² at a frequency of 13.56 MHz may be applied to the electrodes of the chamber to generate the plasma. Alternatively, low frequency RF power, e.g., 400 kHz, may instead be applied to the electrodes.

In another example, a process for depositing a hydrogenated SiN layer on a solar cell substrate using an ammonia-free precursor gas mixture is provided. After the substrates S are positioned in the second of the chambers 103-108 in the processing system 100, a process gas mixture is flowed into the chamber. The process gas mixture includes silane (SiH₄) and nitrogen (N₂) as precursor gases, and is free of ammonia (NH₃). The process gas mixture, according to one aspect, may have substantially the same flow rate of nitrogen and silane as the nitrogen and silane flow rates of a conventional SiN process gas mixture. For example, a conventional SiN process gas mixture, i.e., one commonly used in PECVD chambers for forming a SiN passivation layer may contain 5.5 sccm of silane and 40 sccm of nitrogen, per liter of chamber volume. The process gas mixture, according to another aspect, may have a substantially higher nitrogen flow rate relative to the flow rate of silane, when compared to a corresponding conventional SiN process gas mixture. Hence, another process gas mixture may contain 3.5 sccm of silane and 95 sccm of nitrogen, per liter of chamber volume.

Next, plasma is generated in the processing chamber 103-108 to deposit a SiN layer on the substrates S in a manner substantially the same a described above in the previous example. As with the previous example, the SiN layer so deposited is suitable for use as a combined ARC and passivation layer for a solar cell.

In another example, a process for depositing a SiN dual stack film on a solar cell substrate is provided. After the substrates S have been positioned in the processing chamber 103-108, a first process gas mixture is flowed into the chamber. The first process gas mixture may be on of the gas mixtures described above. Next, plasma is generated in the processing chamber 103-108 to deposit a SiN interface layer on the substrates S substantially the same as described above.

Next, flow of the first process gas mixture is stopped, and a second process gas mixture is flowed into the chamber. The second process gas mixture may be a conventional SiN process gas mixture, i.e., one commonly used in PECVD systems for forming a SiN passivation layer on large area substrates, such as flat panel displays. In one example, the second process gas mixture may contain 5.5 sccm of silane (SiH₄), 16 sccm of ammonia (NH₃), and 40 sccm of nitrogen (N₂), per liter of chamber volume. Optionally, plasma may be extinguished in the chamber after flow of the first process gas mixture is stopped and prior to the introduction of the second process gas mixture. In this case, the first process gas mixture may be substantially purged from the chamber before the second process gas mixture is flowed into the chamber.

Finally, a bulk SiN layer is deposited on the interface layer to form a dual stack SiN ARC/passivation layer on the substrates S. In this way, the majority of the SiN passivation layer may be deposited by a substantially faster process without affecting the quality of solar cell passivation. If plasma is extinguished in the chamber prior to the introduction of the second process gas mixture, then plasma is re-ignited to enable deposition of the bulk SiN layer.

While the foregoing is directed to embodiments of the present invention, other and further embodiments of the invention may be devised without departing from the basic scope thereof, and the scope thereof is determined by the claims that follow.

1. A processing system, comprising:
one or more process chambers each having a substrate supporting surface configured to receive and process an array of substrates positioned on a substrate carrier;
a load lock chamber coupled to the one or more process chambers and having one or more regions with a substrate supporting surface configured to receive and support the array of substrates positioned on the substrate carrier; and
a substrate carrier interface module positioned adjacent the load lock chamber, the substrate carrier interface module, comprising:
one or more substrate transfer modules configured to load substrates onto the substrate carrier and unload substrates off of the substrate carrier; and
a substrate interface module having a transfer robot configured to transfer the array of substrates on the substrate carrier from the one or more substrate transfer modules to the one or more regions of the load lock chamber and from the one or more regions of the load lock chamber to the one or more substrate transfer modules, wherein the one or more substrate transfer modules include at least one of a substrate carrier cooling module, a substrate carrier cleaning module, and a substrate carrier buffer module.

2. The processing system of claim 1, wherein the one or more substrate transfer modules comprise:
a substrate carrier cleaning module;
a substrate carrier lift module;
a first substrate carrier conveyor; and
one or more substrate transfer robots.

3. The processing system of claim 2, wherein the substrate carrier cleaning module comprises:
a carrier conveyor configured to receive a substrate carrier;
one or more lift mechanisms configured to lift the substrate carrier from the carrier conveyor;
one or more cleaning mechanisms configured to clean the substrate carrier;
a waste bin positioned to receive debris removed from the substrate carrier; and
an enclosure positioned to prevent debris from exiting the substrate carrier cleaning module.

4. The processing system of claim 3, wherein the one or more cleaning mechanisms comprises a compressed air device mounted to a linear actuator, wherein the compressed air device substantially spans the width of the substrate carrier positioned in the substrate carrier cleaning module and the linear actuator moves the compressed air device substantially along a length of the substrate carrier cleaning module.

5. The processing system of claim 3, wherein the one or more cleaning mechanisms comprises a vacuum device mounted to a linear actuator, wherein the vacuum device substantially spans the width of the substrate carrier positioned in the substrate carrier cleaning module and the linear actuator moves the vacuum device substantially along a length of the substrate carrier cleaning module.

6. The processing system of claim 2, wherein the substrate carrier lift module comprises a second substrate carrier conveyor attached to an elevator mechanism configured to raise the second substrate carrier conveyor for alignment with the first substrate carrier conveyor and lower the second substrate carrier conveyor for alignment with a carrier conveyor disposed in the substrate carrier cleaning module.

7. The processing system of claim 1, wherein the one or more substrate transfer modules comprise:
a substrate carrier cooling module;
a first substrate carrier conveyor;
a substrate carrier lift module; and
one or more substrate transfer robots.

8. The processing system of claim 7, wherein the substrate carrier cooling module comprises:
one or more carrier lift mechanisms for receiving the substrate carrier;
a carrier conveyor configured to advance the substrate carrier out of the substrate carrier cooling module; and
a substrate carrier cooling plate configured to cool the substrate carrier.

9. The processing system of claim 8, wherein the substrate carrier cooling plate comprises:
one or more conductive blocks having one or more coolant carrying conduits therein, wherein the one or more conductive blocks have an upper surface configured to receive the substrate carrier cooling plate; and
one or more carrier cooling plate lifting mechanisms configured to raise and lower the one or more conductive blocks.

10. The processing system of claim 9, wherein the substrate carrier cooling plate includes vacuum ports disposed therein in fluid communication with a vacuum pump.

11. The processing system of claim 7, wherein the substrate carrier cooling module comprises a forced air cooling device.

12. The processing system of claim 7, wherein the substrate carrier lift module comprises a second substrate carrier conveyor attached to an elevator mechanism configured to raise the second substrate carrier conveyor for alignment with the first substrate carrier conveyor and lower the substrate carrier conveyor for alignment with a carrier conveyor disposed in the the substrate carrier cooling module

13. The processing system of claim 7, further comprising a substrate carrier buffer module, comprising:
a plurality of shelves each configured to receive a substrate carrier thereon;
a plurality of lifting pins configured to raise and lower one or more of the plurality of shelves;
a base plate positioned to support the plurality of lifting pins; and
a linear actuator configured to laterally move the base plate.

14. A substrate carrier loading and unloading system, comprising:
a first substrate transfer module configured to load an array of substrates onto a substrate carrier, the first substrate transfer module comprising:
a substrate carrier cleaning module;
a first substrate carrier lift module;
a substrate carrier loading conveyor; and
one or more first substrate transfer robots;
a second substrate transfer module configured to unload the array of substrates from the substrate carrier, the second substrate transfer module comprising:
a substrate carrier cooling module;
a second substrate carrier lift module;
a substrate carrier unloading conveyor; and
one or more second substrate transfer robots; and
a substrate interface module having a substrate carrier transfer robot configured to transfer the array of substrates on the substrate carrier from the first substrate transfer module into a processing system and out of the processing system to the second substrate transfer module, wherein the substrate carrier transfer robot is further configured to transfer the substrate carrier from the second substrate transfer module to the first substrate transfer module.

15. The system of claim 14, wherein the substrate carrier cleaning module comprises:
a carrier conveyor configured to receive a substrate carrier from the substrate carrier transfer robot;
one or more lift mechanisms configured to lift the substrate carrier from the carrier conveyor;
one or more cleaning mechanisms configured to clean the substrate carrier;
a waste bin positioned to receive debris removed from the substrate carrier; and
an enclosure positioned to prevent debris from exiting the substrate carrier cleaning module.

16. The system of claim 14, wherein the substrate carrier cooling module comprises:
one or more carrier lift mechanisms for receiving the substrate carrier from the substrate carrier transfer robot;
a carrier conveyor configured to advance the substrate carrier out of the substrate carrier cooling module; and
a substrate carrier cooling plate configured to cool the substrate carrier.

17. The system of claim 14, further comprising a substrate carrier buffer module, wherein the substrate carrier buffer module, comprises:
a plurality of shelves each configured to receive and store a substrate carrier thereon;
a plurality of lifting pins configured to raise and lower one or more of the plurality of shelves;
a base plate positioned to support the plurality of lifting pins; and
a linear actuator configured to laterally move the base plate.

18. A method of forming a solar cell device, comprising:
cleaning a substrate carrier in a carrier cleaning module;
transferring the substrate carrier from the carrier cleaning module to a substrate loading position in a first substrate transfer module;
positioning an array of substrates on the substrate carrier in the first substrate transfer module;
transferring the substrate carrier from the first substrate transfer module to a load lock chamber using a substrate carrier transfer robot;
transferring the substrate carrier from the load lock chamber to one or more process chambers and processing the array of substrates on the substrate carrier;
transferring the substrate carrier from the one or more process chambers to the load lock chamber;
transferring the substrate carrier from the load lock chamber to a carrier cooling module using the substrate carrier transfer robot and cooling the substrate carrier in the carrier cooling module;
transferring the substrate carrier from the carrier cooling module to a substrate unloading position in a second substrate transfer module; and
removing the array of substrates from the substrate carrier in the second substrate transfer module.

19. The method of claim 18, wherein cleaning the substrate carrier comprises:
receiving the substrate carrier onto a carrier conveyor within the carrier cleaning module;
raising the substrate carrier to a cleaning position using a plurality of lift mechanisms;
cleaning the substrate carrier using a debris removal device coupled to a linear actuator;
lowering the substrate carrier onto the carrier conveyor using the plurality of lift mechanisms; and
transferring the substrate carrier out of the carrier cleaning module using the carrier conveyor.

20. The method of claim 18, wherein cooling the substrate carrier comprises:
receiving the substrate carrier onto a plurality of lift mechanisms within the carrier cooling module;
positioning the substrate carrier onto a cooling plate using the plurality of lift mechanisms;
cooling the substrate carrier using the cooling plate;
lowering the cooling plate to position the substrate carrier onto a carrier conveyor; and
transferring the substrate carrier out of the carrier cooling module using the carrier conveyor.
